(19) United States
(12) Patent Application Publication
(10) Pub. No.: US 2013/0049509 A1
(43) Pub. Date: Feb. 28, 2013

(54) HIGH EFFICIENCY MOTOR UTILIZING REPULSIVE FORCE OF PERMANENT MAGNET

(71) Applicant: Kwoang Seog Shin, Seoul (KR)

(72) Inventor: Kwoang Seog Shin, Seoul (KR)

(21) Appl. No.: 13/510,983

(22) PCT Filed: Oct. 26, 2010
(86) PCT No.: PCT/KR10/07373

§ 371 Date: May 21, 2012

(30) Foreign Application Priority Data
Nov. 19, 2009 (KR) 10-2009-0112010

(51) Int. Cl. H02K 21/04

(52) U.S. Cl. 310/152

(57) ABSTRACT

The present invention relates to improving the efficiency of electric motors by utilizing the repulsive force between the same poles of adjacent permanent magnets. The invention comprises: a rotating magnet and a fixed magnet, wherein the same poles of said magnets are placed to face each other; a magnet control bundle inserted into a side of the fixed magnet; and an electromagnet and a repulsion plate inserted between the space separating the rotating magnet as it approaches the fixed magnet, such that the electric current from the electromagnet off-sets the repulsive force generated therein, and wherein said repulsion plate maximizes the repulsion force when the rotating magnet moves away from the center of the fixed magnet and moves towards the side of the fixed magnet. Accordingly, the present invention provides a high-efficiency, high-speed, Brushless-type rotation motor which is based on the Hall non-contact electromagnetic effect, and uses a number of rotating magnets which number is greater than the number of fixed magnets and the electromagnet provides controlled instantaneous current when the rotating magnets approach the sides of the fixed magnets, such that less external power supply is required.

### TECHNICAL FIELD

The present invention aims at obtaining high output by supplying less energy in driving of a electric motor, wherein in utilizing of repulsive force between the same poles according to a principle of permanent magnet, with regard to attaching of a magnetic field line control assembly to the permanent magnet of a stator in order to minimize the repulsive force generated when a rotatable magnet approaches a fixed magnet, a magnetic field line-decreasing plate is inserted for converting the direction of magnetic field line of approach direction into a horizontal direction, and an electromagnet is mounted on it to momentarily cause a reverse polarity, and a magnetic field line-increasing plate is inserted in such a way that the direction of magnetic field line is vertical on a side where the rotatable magnet retreats from the fixed magnet, whereby the repulsive force is maximized when the rotatable magnet retreats from the fixed magnet, and the number of the rotatable magnets is greater than the number of the fixed magnets, whereby when one of the rotatable magnets approaches the fixed magnet, another two rotatable magnets are repulsed, and supplying of electric current to the electromagnet for decreasing the repulsive force at the time of approach is switched in a non-contact manner using Hall elements for detecting an approach position of the rotatable magnet, and thus a high-efficiency motor is achieved.

### BACKGROUND ART

For two permanent magnets, attractive force exists between different poles and repulsive force exists between the same poles. For utilizing the repulsive force generated between the same poles, one permanent magnet is fixed and another one is attached on a rotatable body. Since the repulsive force generated when the permanent magnet attached to the rotatable body approaches the fixed permanent magnet is equal to the repulsive force generated when the permanent magnet attached to the rotatable body retreats from a center of the fixed permanent magnet, as a way to decrease the repulsive force at the time of approach, using of semi-magnetic material or liquid magnet etc. exhibits a slight magnetic field line-shielding effect in room temperature, thus it is difficult to obtain desired torque, therefore, in order to maximize the repulsive force at the time of retreat and minimize the repulsive force at the time of approach by attaching the magnetic field line control assembly, i.e., the magnetic field line-decreasing plate, electromagnet and magnetic field line-increasing plate to the fixed permanent magnet, the position of the permanent magnet of the rotatable body is detected to open and shut down supply of the electric current to the electromagnet, thereby realizing a high- efficiency electric motor.

### DISCLOSURE OF THE INVENTION

The present invention relates to a method for realizing a high-efficiency electric motor, more particularly, realizes a high-efficiency motor by inserting a magnetic field line control assembly decreasing the repulsive force at the time of approach and increasing the repulsive force at the time of retreat in utilizing of the repulsive force generated between the same poles of the permanent magnets.

In the case of most of conventional electric motors, coil is wound around a iron core, and in rotating of a rotor by causing variation of magnetic field line of the iron core by means of control of the direction of electric current of the coil, the direction of electric current of the coil is controlled by using a brush or waveform generator, therefore, heat loss is generated according to material for the iron core and coil and frictional resistance and wear of the brush easily occur, and thus a lot of efforts are made for reducing such losses.

In the present invention, for realizing a high-efficiency electric motor, with regard to insertion of the magnetic field line control assembly which is an essential element, the magnetic field line-decreasing plate is inserted on a approach side, which plate cause the magnetic field line to be horizontal, thereby decreasing the repulsive force at the time of approach, and the electromagnet is inserted on the magnetic field line-decreasing plate, which electromagnet is supplied with the electric current only at the time of approach, thus the direction of the magnetic field line is reversed to minimize the repulsive force at the time of approach, and the magnetic field line-increasing plate is inserted on a retreat side, and the magnetic field line-increasing plate cause the magnetic field line to be vertical, thereby maximizing the repulsive force at the time of retreat, and the approach position of the rotatable magnet is detected in a non-contact manner using Hall elements to control the electric current of the electromagnet, whereby a high-efficiency motor of brushless type is realized.

The present invention relates to a high-efficiency electric motor, wherein efficiency of output torque of the motor is high for supplied electric energy and the motor is semi-permanent due to its brushless type and allows a high speed rotation. For checking of the facts, measurement was carried out using a prototype produced for test (FIG. 16), and as a result, the prototype has achieved 5000 rpm with input of 2.3 Watt, 7700 rpm with input of 6 Watt and 10000 rpm with input of 12 Watt, and the efficiency will be further increased if the prototype is produced as mass product by improving mechanism structure, and since the motor of the present invention has much higher efficiency than conventional electric motor, it can be applied to electric automobiles using an electric motor driven by a storage battery or special products requiring a high-speed rotation, and therefore is expected to make a great contribution to increasing of energy efficiency.

### BRIEF DESCRIPTION OF THE DRAWINGS

FIG. 1 is a view illustrating a basic example of the present invention.

FIG. 2 is a constructional view of a magnetic field line control assembly inserted in a fixed body of the example.

FIG. 3 is a simple circuit diagram for controlling electric current of an electromagnet of the example.

FIGS. 4 to 7 are views explaining rotation of the present invention by stages.

FIGS. 8 to 10 are views comparing variations of the magnetic field line in the magnetic field line control assembly of the present invention.

FIGS. 11 to 13 are views comparing variations of the magnetic field line when only electromagnet is attached to a permanent magnet.

FIG. 14 is a view showing sequences for supplying electric current to each of coils of the magnetic field line control assemblies of the present invention.

FIG. 15 is a view illustrating another example of the present invention.

FIG. 16 is a picture of a prototype produced for testing the basic example of the present invention.

### MODES FOR CARRYING OUT THE INVENTION

Examples of the present invention will be described in detail with reference to the attached drawings.

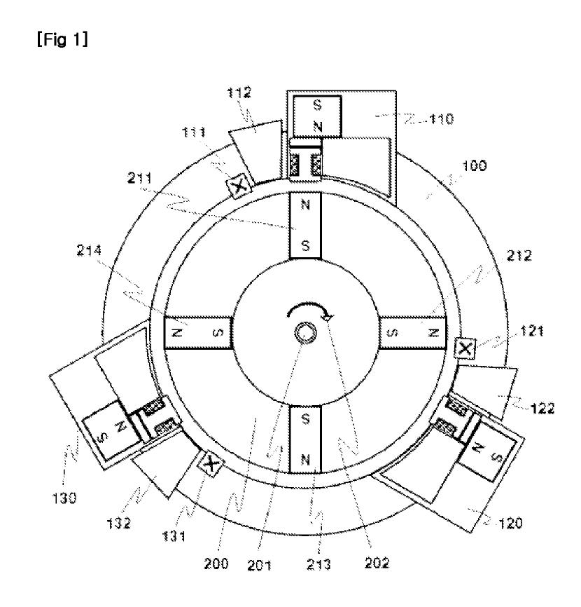

FIG. 1 is a view illustrating a basic example of the present invention. External configuration of a motor is achieved by securing stator magnetic field line control assemblies (110, 120, 130), bearings coupled to a rotatable shaft (201), Hall elements (111, 121, 131) for detecting positions of permanent magnets of a rotatable body, and electromagnet control board (112, 122, 132) for controlling electric current in coils etc. to a fixed stand (100). For the rotatable body, a rotatable plate (200) is fixed to the rotatable shaft (201), and permanent magnets (211, 212, 213, 214) are fixedly arranged on the rotatable plate (200) at a uniform interval with the same pole (N poles) facing the fixed magnets. If electric power is supplied, the rotatable body rotates as illustrated by rotation indication direction (202).

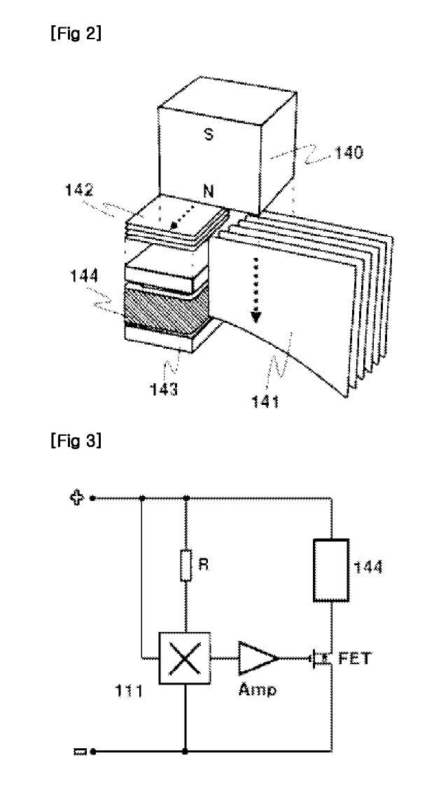

FIG. 2 shows the magnetic field line control assembly (110), which is an essential element of the present invention, for controlling direction of the magnetic field line of the permanent magnets attached to the fixed stand (100). A repulsive force-decreasing plate (142) is fixed on a rotatable magnet-approaching side with respect to a center of the permanent magnet (140), while a repulsive force-increasing plate (141) is fixed on a rotatable magnet-retreating side, and the electromagnet with a coil (144) wound around an electromagnet core (143) is attached to the repulsive force-decreasing plate (142). The electromagnet core (143) is made of magnetic material such as ferrite and is wound at its middle portion with the coil (144). If electric current flows in the coil (144), the electromagnet core (143) is magnetized to become an electromagnet. At this time, since the direction of magnetic pole of the electromagnet is opposite that of the permanent magnet (140), the magnetic field line of the permanent magnet (140) is inhibited from flowing toward the electromagnet core (143), and the repulsive force-decreasing plate (142) is formed by stacking several sheets of silicon steel plates and is attached so as to be horizontal with the direction of the magnetic field line of the permanent magnet (140) to cause vertical direction of the magnetic field line of the permanent magnet (140) to be horizontal, thereby decreasing the magnetic field line flowing toward the electromagnet core (143), while the repulsive force-increasing plate (141) is formed by stacking several sheets of silicon steel plates and is attached so as to be perpendicular to the direction of the magnetic field line of the permanent magnet (140), thereby increasing the magnetic field line of the permanent magnet (140) flowing toward the rotatable magnets.

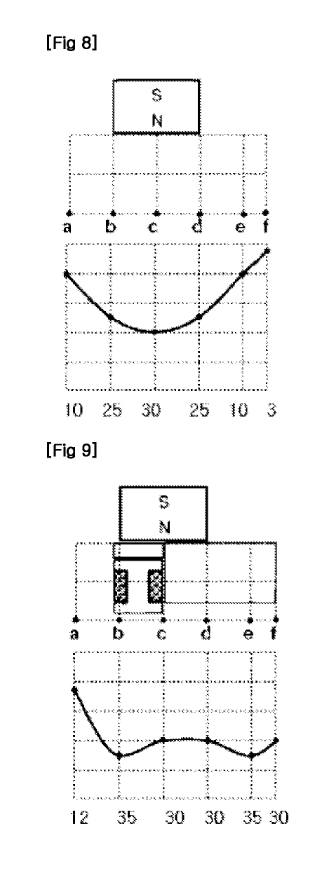

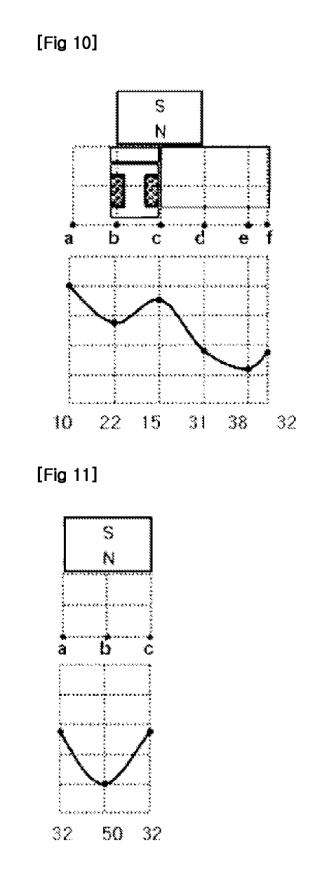

With reference to FIGS. 8 to 10, description will be made of variation of the magnetic field line due to insertion of the magnetic field line control assembly as described above. FIG. 8 illustrates intensity of the magnetic field line for each of points (a, b, c, d, e, f) of horizontal direction offset from the permanent magnet at a regular distance therefrom by a graph with measured values indicated, and FIG. 9 illustrates intensity of the magnetic field line for each of points (a, b, c, d, e, f) by a graph with measured values indicated, when the magnetic field line-decreasing plate, electromagnet core and magnetic field line-increasing plate are attached to the permanent magnet of the magnetic field line control assembly. Comparing the graphs in FIGS. 8 and 9, since the magnetic field line control assembly is used, the intensity of the magnetic field line around the point “e” on the rotatable magnet-retreating side is significantly elevated, whereby the repulsive force at the time of retreat is increased. FIG. 10 illustrates intensity of the magnetic field line for each of points (a, b, c, d, e, f) by a graph with measured values indicated when the electric current flows in the coil and the direction of the magnetic pole of the electromagnet is opposite that of the permanent magnet. Comparing the graphs in FIGS. 9 and 10, the intensity of the magnetic field line at point “b” on the rotatable magnet-approaching side is weakened, whereby the repulsive force at the time of approach is decreased, and when the rotatable magnet approaches the electromagnet core, since the electromagnet core is a magnetic body, force attracting the rotatable magnet exists, whereby the repulsive force at the time of approach is further weakened.

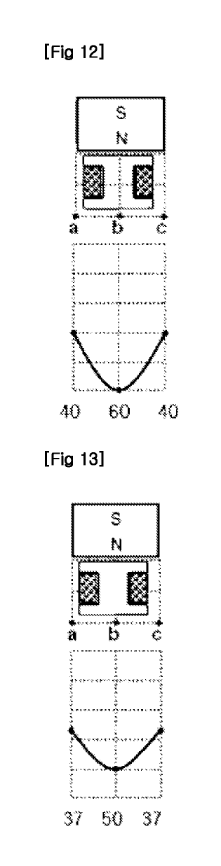

FIGS. 11 to 13 are views illustrating variations of the magnetic field line measured when only electromagnet is attached to the permanent magnet, wherein FIG. 11 is a view showing measured intensity of the magnetic field line of the permanent magnet, FIG. 12 is a view showing measured intensity of the magnetic field line when the electromagnet core is attached to the permanent magnet, and FIG. 13 is a view showing measured intensity of the magnetic field line when the electric current flows in the electromagnet coil and the direction of the magnetic pole of the electromagnet is opposite that of the permanent magnet. Comparing the intensity of magnetic field at point “b” in FIGS. 12 and 13, the magnetic field line is decreased by about 17% by supplying the coil with electric current corresponding to average electric power of 4 Watt, while for intensity of magnetic field at point “b” in FIGS. 9 and 10, as compared, the magnetic field line is decreased by about 37% by supplying the coil with electric current corresponding to average electric power of 2 Watt by using the magnetic field line control assembly.

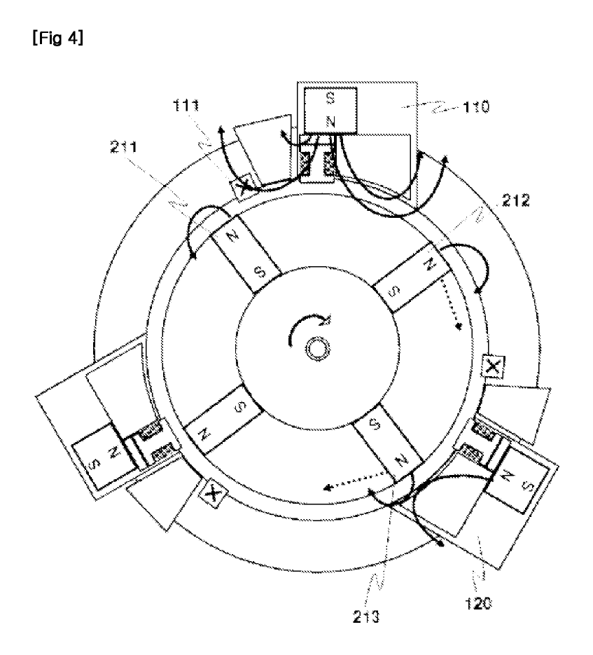

FIG. 3 is a simple circuit diagram for controlling electric current in the coil. The Hall element (111) is supplied with electric power via a resistance (R), and FET is operated by amplifying the variation of voltage of the Hall element (111) through Amp while the rotatable magnet (211) approaches the Hall element (111), thus electric current flows in the electromagnet coil (144), thereby magnetizing it into an electromagnet. Each of the Hall elements (111, 121, 131) corresponding to each of the electromagnet control board (112, 122, 132) is attached on a side where the rotatable magnet approaches the fixed magnet, and supplies the electric current to a coil of relevant one of the magnetic field line control assemblies (110, 120, 130) each time the rotatable magnet approaches the fixed magnet.

FIGS. 4 to 7 are views explaining rotation of a basic example of the present invention by stages.

FIG. 4 shows that the rotatable magnet (211) is in a position before it approaches the magnetic field line control assembly (110) of the fixed magnet, wherein curved arrows around the magnetic field line control assembly (110) indicate the direction of the magnetic field line. The permanent magnet (211) is rotated by repulsive force between the magnetic field line control assembly (120) and permanent magnet (213) and the repulsive force between the magnetic field line control assembly (110) and permanent magnet (212) to approach the Hall element (111) coupled to the magnetic field line control assembly (110).

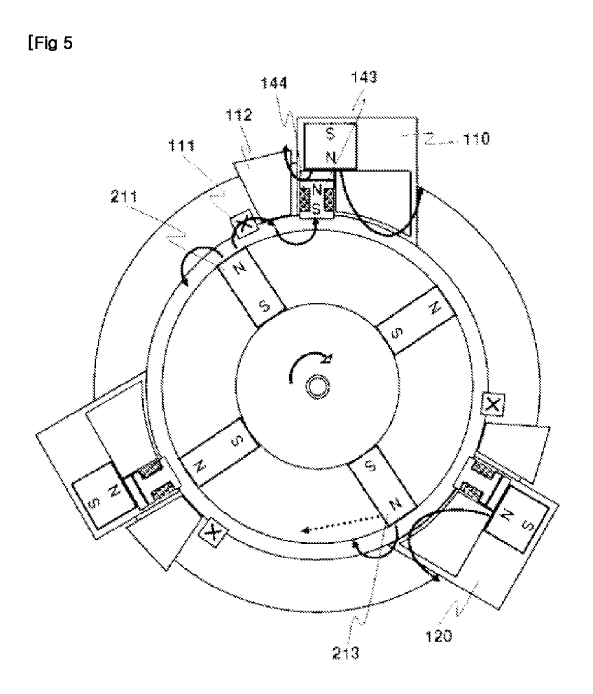

With reference to FIG. 5, if the rotatable body rotates clockwise and thus the permanent magnet (211) is adjacent to the Hall element (111),the electromagnet control board (112) supplies the electromagnet coil (144) with the electric current, whereby the core (143) is magnetized in such a direction that the core attracts the permanent magnet (211), and at the same time, the permanent magnet (211) approaches the magnetic field line control assembly (110) by means of the repulsive force between the magnetic field line control assembly (120) and permanent magnet (213).

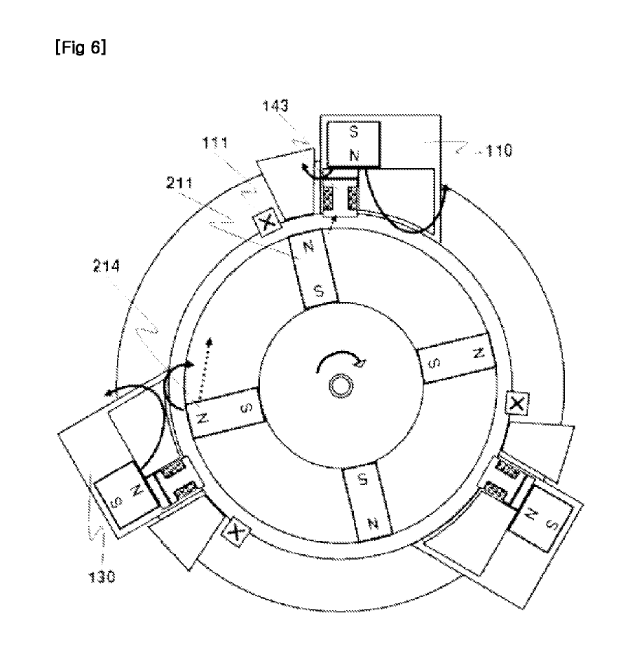

With reference to FIG. 6, if the permanent magnet (211) is past the Hall element (111), the electric current in the electromagnet coil (144) is stopped, whereby the electromagnet core (143) is converted from the electromagnet to a magnetic body, thereby attracting the permanent magnet (211) in a direction of dotted arrow, and at the same time is rotated by the repulsive force between the permanent magnet (214) and magnetic field line control assembly (130).

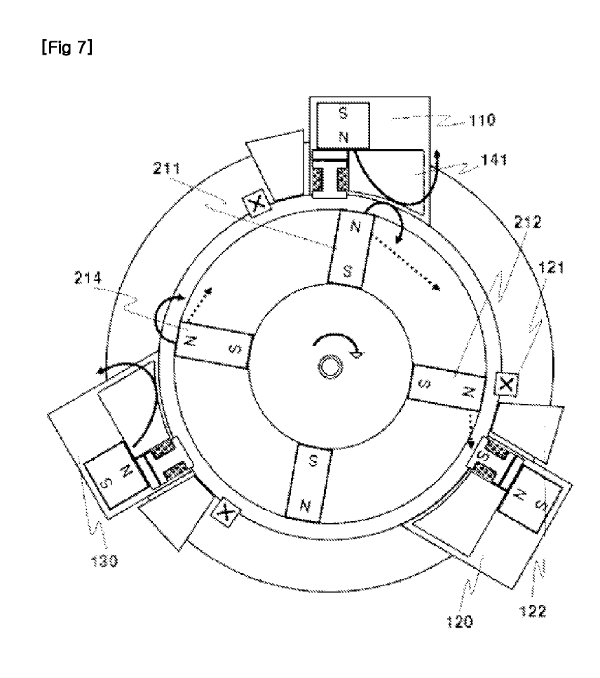

With reference to FIG. 7, the permanent magnet (211) is further rotated by the repulsive force between the permanent magnet (214) and magnetic field line control assembly (130) to be positioned facing the repulsive force-increasing plate (141) of the magnetic field line control assembly (110), whereby the permanent magnet (211) is pushed in a direction of dotted arrow and at the same time the permanent magnet (212) approaches the magnetic field line control assembly (120).

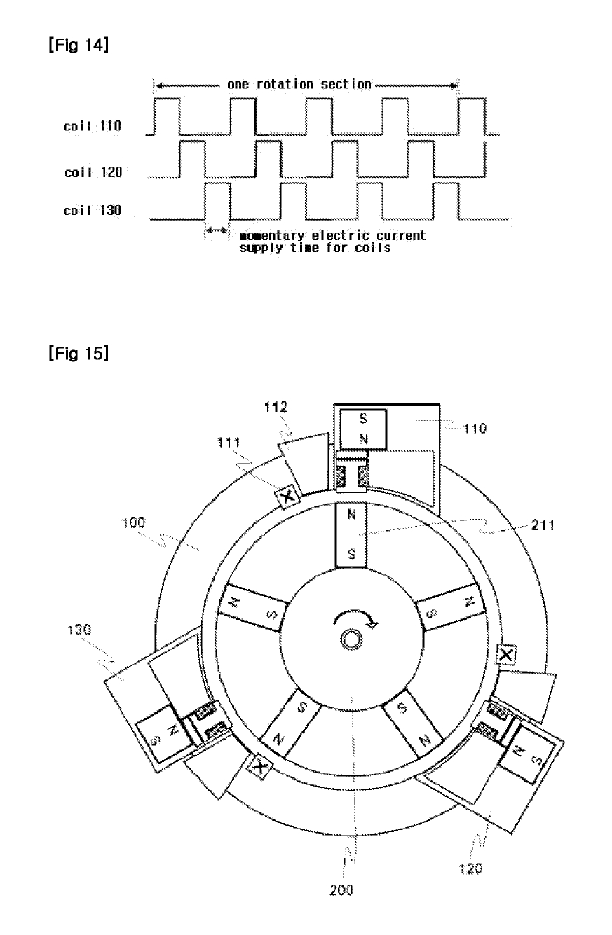

In such a way as described above, the rotatable body continues to rotate clockwise, and supplying of the electric power to each of the coils in the magnetic field line control assemblies (110, 120, 130) is carried out sequentially for each coil as seen in FIG. 14. If the rotatable body rotates at a velocity of 5000 rpm, a time taken for one rotation section is 12 mSec and momentary electric current supply time for the coils is 1 mSec.

FIG. 15 is a view illustrating another example of the present invention. Three magnetic field line control assemblies are provided in the fixed body as described above and five permanent magnets are provided in the rotatable body, wherein when one of the permanent magnets of the rotatable body approaches the magnetic field line control assembly, another two permanent magnets of the rotatable body receive the repulsive force from the magnetic field line control assembly, therefore, efficiency will be improved compared to a case where four permanent magnets are provided in the rotatable body.

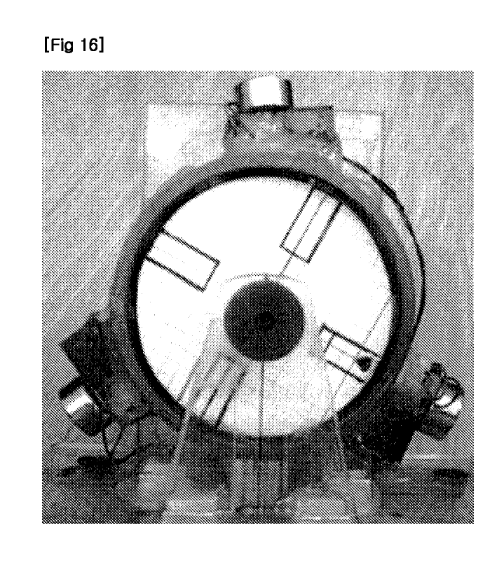

FIG. 16 is a picture of a prototype produced for test for actually checking the basic example of the present invention, and each of the above-mentioned measured values was measured with the prototype. This prototype has achieved 5000 rpm with input of 2.3 Watt, 7700 rpm with input of 6 Watt and 10000 rpm with input of 12 Watt.

What is claimed:

1. A high-efficiency motor utilizing repulsive force of permanent magnet, wherein the motor utilizes the repulsive force generated between the same poles of the permanent magnets, and the permanent magnets of a fixed body and permanent magnets of a rotatable body all have the same direction, whereby the repulsive force acts between the permanent magnets of the fixed body and permanent magnets of the rotatable body, and a magnetic field line control assembly (110) is inserted in the permanent magnet of the fixed body in such a way that the repulsive force is maximized when the permanent magnet of the rotatable body retreats from the permanent magnet of the fixed body and the repulsive force is minimized when the permanent magnet of the rotatable body approaches the permanent magnet of the fixed body, and the repulsive force at the time of approach is decreased by detecting a position of the permanent magnet of the rotatable body at the time of approaching the magnetic field line control assembly of the fixed magnet and then magnetizing an electromagnet in the magnetic field line control assembly.

2. The high-efficiency motor utilizing repulsive force of permanent according to claim 1, wherein for a structure of the magnetic field line control assembly (110), a repulsive force-decreasing plate (142) is attached on a rotatable magnet-approaching side with respect to a center of a permanent magnet (140), while a repulsive force-increasing plate (141) is attached on a rotatable magnet-retreating side, and a core (143) and coil (144) constituting the electromagnet are mounted on the repulsive force-decreasing plate (142).

3. The high-efficiency motor utilizing repulsive force of permanent according to claim 1, wherein Hall element (111) is attached on a side where the permanent magnet of the rotatable body approaches the magnetic field line control assembly of the fixed body, and if the rotatable magnet is adjacent to the Hall element, the electromagnet in the magnetic field line control assembly is magnetized in a reverse direction, whereby intensity of magnetic field line of the permanent magnet of the fixed body is weakened, and it cooperates with the magnetic field line-decreasing plate (142) to minimize the repulsive force at the time of approach, and when the permanent magnet of the rotatable body retreats from the center of the permanent magnet of the fixed body, the repulsive force is maximized by the magnetic field line-increasing plate (141).

4. The high-efficiency motor utilizing repulsive force of permanent according to claim 1, wherein the number of the permanent magnets of the rotatable body is greater than the number of the permanent magnets of the fixed body, whereby when one of the permanent magnets of the rotatable body approaches the permanent magnet of the fixed body, another permanent magnets of the fixed body can give the repulsive force to two or more permanent magnets of the rotatable body.
